(19) United States
(12) Patent Application Publication
(10) Pub. No.: US 2011/0256860 A1
(43) Pub. Date: Oct. 20, 2011

(54) WIRELESS BASE STATION, TERMINAL, WIRELESS COMMUNICATION SYSTEM, AND WIRELESS COMMUNICATIONS METHOD

(75) Inventors: Daisuke NITTA, Kawasaki (JP); Tomonori KUMAGAI, Kawasaki (JP)

(73) Assignee: FUJITSU LIMITED, Kawasaki-shi (JP)

(21) Appl. No.: 13/173,908

(22) Filed: Jun. 30, 2011

Related U.S. Application Data
(63) Continuation of application No. PCT/JP2009/050078, filed on Jan. 7, 2009.

(51) Int. Cl. H04W 4/00; H04W 88/02; H04W 88/08

(52) U.S. Cl. 455/422.1; 455/561; 455/550.1

(57) ABSTRACT

A wireless base station includes a communicator that performs wireless communication with a subordinate terminal, using any one among various types of wireless channels; and a processor to control the wireless base station in accordance with a process including: analyzing a utilization state of the wireless channel used by the terminal; and controlling information delivered to the terminal, according to the analyzing results.

### CROSS REFERENCE TO THE RELATED APPLICATIONS

This application is a continuation application of International Application PCT/JP2009/050078, filed Jan. 7, 2009, and designating the U.S., the entire contents of which are incorporated herein by reference.

### FIELD

The embodiments discussed herein are related to a wireless base station, a terminal, a wireless communication system, and a wireless communications method.

### BACKGROUND

Recently, wireless communication systems are known in which, user authentication data, terminal information and encrypted information are received by infrared communication or communication using an IC card, and based on the received information, a position registration request is made to an ultrasmall wireless base station, and communication between a mobile terminal and an ultrasmall wireless base station device is controlled (see, for example, International Publication Pamphlet No. 2005/096656).

Nonetheless, in such conventional wireless communication systems, the wireless base station cannot send pertinent information to users of subordinate terminals.

### SUMMARY

According to an aspect of an embodiment, a wireless base station includes a communicator that performs wireless communication with a subordinate terminal, using any one among various types of wireless channels; and a processor to control the wireless base station in accordance with a process including: analyzing a utilization state of the wireless channel used by the terminal; and controlling information delivered to the terminal, according to the analyzing results.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts a configuration of a wireless communication system of a first embodiment.

FIG. 2 depicts operation of the wireless communication system of the first embodiment.

FIG. 3 depicts a configuration of the wireless communication system of a second embodiment.

FIG. 4 depicts a configuration of the wireless communication system of a third embodiment.

FIG. 5 depicts a configuration of the wireless communication system of a fourth embodiment.

FIG. 6 depicts a configuration of a wireless base station of a fifth embodiment.

FIG. 7 depicts an example of a communication state.

FIG. 8 depicts an example of information stored in a storage unit.

FIG. 9 depicts an example of information stored in a utilization state database.

FIG. 10 depicts an example of information stored in an advertisement database.

FIG. 11 depicts a configuration of a terminal of the fifth embodiment.

FIG. 12 depicts a configuration of a display device of the fifth embodiment.

FIG. 13 depicts a configuration of a mobile-communications provider apparatus of the fifth embodiment.

FIG. 14 depicts an example of information stored in a subscriber database.

FIG. 15 depicts a configuration of an advertising-delivery provider apparatus of the fifth embodiment.

FIG. 16 depicts a configuration of a router of the fifth embodiment.

FIG. 17 depicts operation for delivering an advertisement to a terminal, in the fifth embodiment.

FIG. 18 depicts an example of display by the terminal.

FIG. 19 depicts a process of analyzing wireless channel state and writing to the utilization state database in the fifth embodiment.

FIG. 20 depicts an example of analysis results for the utilization state of a wireless channel of a user.

FIG. 21 depicts an example of the utilization state database after the analysis results have been written thereto.

FIG. 22 depicts an example of information for instructing a delivering unit.

FIG. 23 depicts a process of searching the advertisement database for an advertisement, in the fifth embodiment.

FIG. 24 depicts a continuation of the process depicted in FIG. 23.

FIG. 25 depicts information instructed to a wireless control unit.

FIG. 26 depicts operation for delivering an advertisement to a display device, in the fifth embodiment.

FIG. 27 depicts an example of information transmitted to a delivering unit.

FIG. 28 depicts an example of selected advertisements to be displayed for each user.

FIG. 29 depicts an example of information transmitted to a receiving unit of the display device.

FIG. 30 depicts a display example of the display device.

FIG. 31 depicts operation for updating the utilization state database in the fifth embodiment.

FIG. 32 depicts a process of updating the utilization state database in the fifth embodiment.

FIG. 33 depicts an example of the utilization state database after updating.

FIG. 34 depicts operation for delivering the advertisement database in the fifth embodiment.

FIG. 35 depicts an example of the advertisement database to which target information has not been assigned.

FIG. 36 depicts one example of a hardware configuration of the wireless base station.

### DESCRIPTION OF EMBODIMENTS

Preferred embodiments of the present invention will be explained with reference to the accompanying drawings.

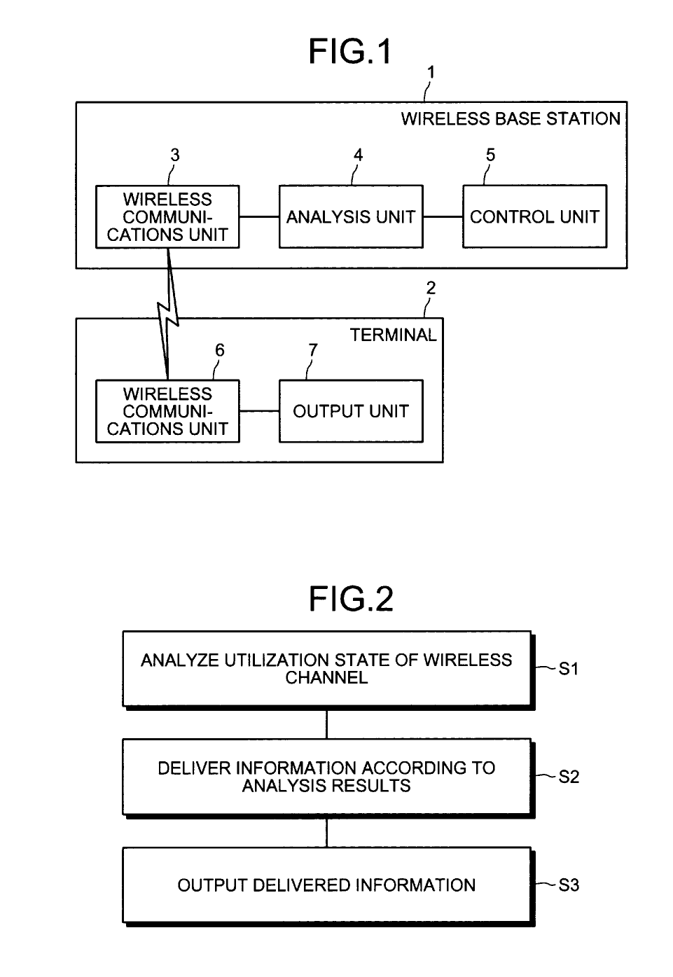

FIG. 1 depicts a configuration of a wireless communication system of a first embodiment. As depicted in FIG. 1, the wireless communication system includes a wireless base station 1 and one or more terminals 2. The wireless base station 1 includes a wireless communications unit 3, an analysis unit 4, and a control unit 5. The wireless communications unit 3 communicates with the subordinate terminal 2 using a wireless channel among various types of wireless channels. The wireless channel is selected based on the communicated content (e.g., moving picture, web browser, still picture, etc.) to be viewed by a user of the terminal 2. The analysis unit 4 analyzes the utilization state of the wireless channel used by the terminal 2. According to the analysis results obtained by the analysis unit 4, the control unit 5 controls the information to be delivered to the terminal 2. The terminal 2 includes a wireless communications unit 6 and an output unit 7. The wireless communications unit 6 uses a wireless channel among the various types of wireless channels to communicate wirelessly with the wireless base station 1. The output unit 7 outputs the information from the wireless base station 1, delivered according to the type of wireless channel used for communication with the wireless base station 1.

FIG. 2 depicts operation of the wireless communication system of the first embodiment. As depicted in FIG. 2, when the wireless base station 1 and the subordinate terminal 2 communicate using a wireless channel among the various types of wireless channels, the wireless base station 1, via the analysis unit 4, analyzes the utilization state of the wireless channel used by the terminal 2 (step S1). According to analysis results of the utilization state of the wireless channel, the wireless base station 1 delivers information to the terminal 2 (step S2). The terminal 2 outputs the information delivered from the wireless base station 1 (step S3). According to the first embodiment, the wireless base station 1 delivers according to the wireless channel used by the terminal 2, information to the terminal 2, whereby information pertinent to the user of the terminal 2 can be delivered from the wireless base station 1.

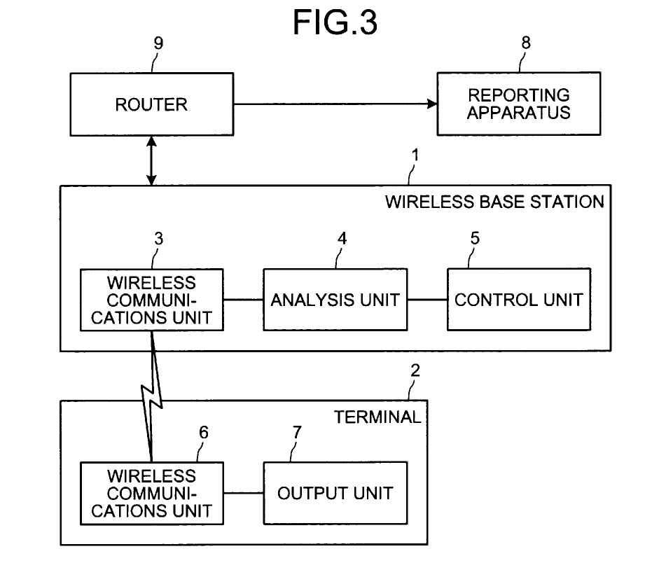

FIG. 3 depicts a configuration of the wireless communication system of a second embodiment. As depicted in FIG. 3, the wireless communication system further includes a reporting apparatus 8 in addition to the configuration of the first embodiment. In the second embodiment, information from the wireless base station 1, delivered according to the utilization state of the wireless channel between the wireless base station 1 and the terminal 2, is delivered to the reporting apparatus 8 via, for example, a router 9. The reporting apparatus 8 outputs the information delivered from the wireless base station 1. The information delivered from the wireless base station 1 may be output from both the output unit 7 of the terminal 2 and the reporting apparatus 8. According to the second embodiment, information pertinent to multiple users in a vicinity of the wireless base station 1 can be delivered from the wireless base station 1, since the wireless base station 1 delivers according to the wireless channel used by the terminal 2, information to the reporting apparatus 8.

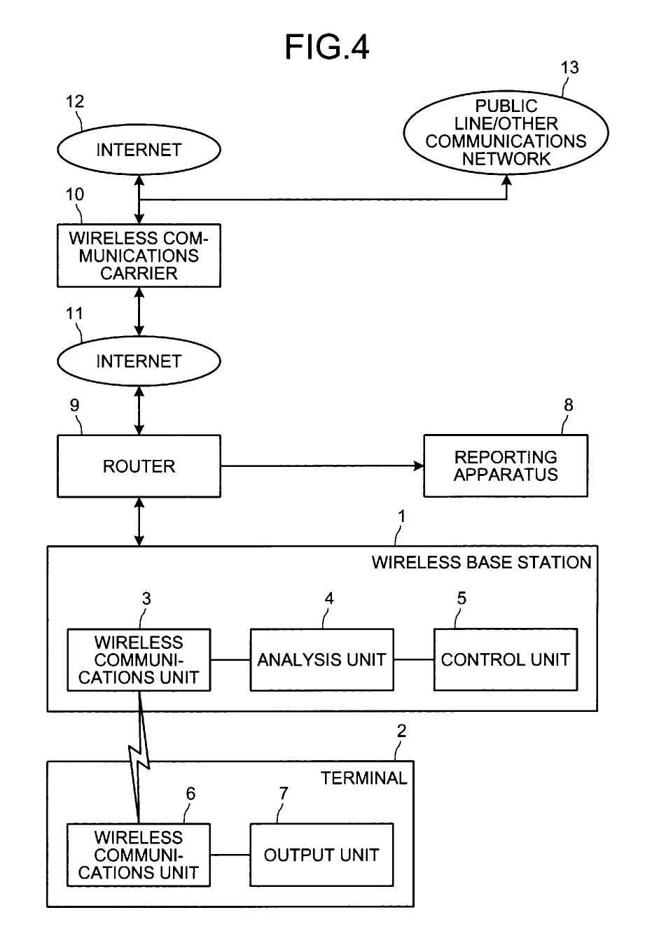

FIG. 4 depicts a configuration of the wireless communication system of a third embodiment. As depicted in FIG. 4, in the wireless communication system in the third embodiment, the wireless base station 1 correlates and transmits to a wireless communications carrier 10, the utilization state of the wireless channel and information related to the user of the terminal 2. The communication of information between the wireless base station 1 and the wireless communications carrier 10 is performed, for example, through the router 9 and an internet 11. Further, the wireless communications carrier 10 is connected to an internet 12 and/or a public line/other communications network 13. According to the third embodiment, the wireless communications carrier 10 can acquire information correlating the utilization state of the wireless channel and information related to the user of the terminal 2.

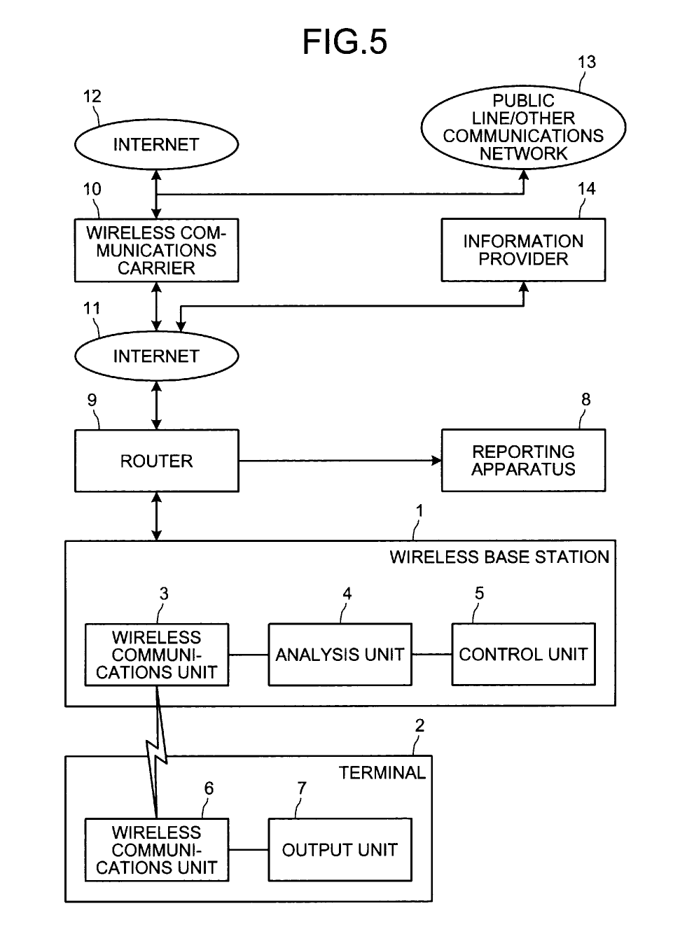

FIG. 5 depicts a configuration of the wireless communication system of a fourth embodiment. As depicted in FIG. 5, the wireless communication system in the fourth embodiment, using information that an information provider 14 has, updates information that the wireless base station 1 has and that is to be delivered according to the utilization state of the wireless channel, to the terminal 2. According to the fourth embodiment, the information provider 14 can update information that is from the wireless base station 1 and that is to be delivered according to the utilization state of the wireless channel, to the terminal 2.

In the first to the fourth embodiments, a mobile communications system of a Third Generation Partnership Project (3GPP) compliant Wideband Code Division Multiple Access (W-CDMA) scheme may be given as an example of the wireless communication system. A small base station, i.e., a so-called femtocell (also referred to as, an ultrasmall base station device, small-scale wireless base station, home base station or indoor base station) may be given as an example of the wireless base station 1. A 3GPP compliant mobile terminal may be given as an example of the terminal 2. Advertisement information may be given as an example of the information from the wireless base station 1, delivered according to the utilization state of the wireless channel between the wireless base station 1 and the terminal 2. A display device that displays moving pictures and/or still pictures, and a speaker that outputs sound may be given as examples of the reporting apparatus 8. A mobile telephone carrier may be given as an example of the wireless communications carrier 10. An advertising delivery provider that delivers advertisement information may be given as an example of the information provider 14. Hereinafter, an example will be described in which the communication standard is assumed to be 3GPP, the communication scheme is assumed to be W-CDMA, and the wireless base station is assumed to be a femtocell in the wireless communication system of the fourth embodiment.

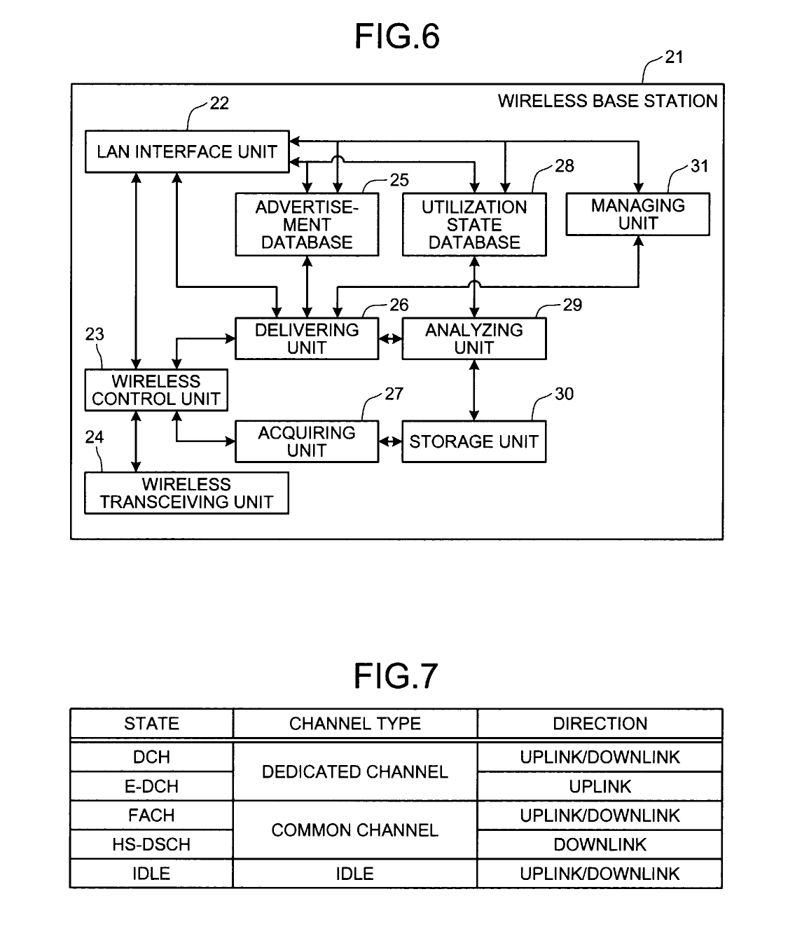

FIG. 6 depicts a configuration of a wireless base station of a fifth embodiment. The wireless base station is, for example, W-CDMA compliant, installed at a residence, an office, or a commercial entity, and can communicate simultaneously with approximately four terminals in a communication range having a radius on the order of several tens of meters. As depicted in FIG. 6, a wireless base station 21 includes a LAN interface unit 22, a wireless control unit 23, a wireless transceiving unit 24, an advertisement database 25, a delivering unit 26, an acquiring unit 27, a utilization state database 28, an analyzing unit 29, a storage unit 30, and a managing unit 31.

The wireless transceiving unit 24, based on 3GPP communication control standards, transmits and receives wireless signals by a physical channel between a terminal and the wireless base station 21. The wireless control unit 23, based on 3GPP communication control standards, controls the communication connection (session), a wireless channel (transport channel), etc. between the terminal and the wireless base station 21. In FIG. 7, an example of wireless channels and idling controlled by the wireless control unit 23 is depicted.

FIG. 7 depicts an example of a communication state. As depicted in FIG. 7, according to 3GPP standards, the communication state is controlled such that a dedicated channel (DCH) can exclusively use a communication rate of approximately 384 Kbps; an enhanced dedicated channel (E-DCH) can use a communication rate of approximately 2 Mbps or more; a forward access channel (FACH) uses and shares with other users, a low rate; and a high speed downlink shared channel (HS-DSCH) uses and shares with other users, a high rate of 7 Mbps or more. Furthermore, if the state of non-communication is long, there is a communication state in which a transport channel is not used as an idle state. Under 3GPP standards, a radio resource control (RRC) signal is transmitted and received between the wireless control unit 23 of the wireless base station 21 and the wireless control unit of each terminal, whereby the communication states can be controlled. Therefore, the wireless control unit 23 is able to grasp the radio channel state for each terminal.

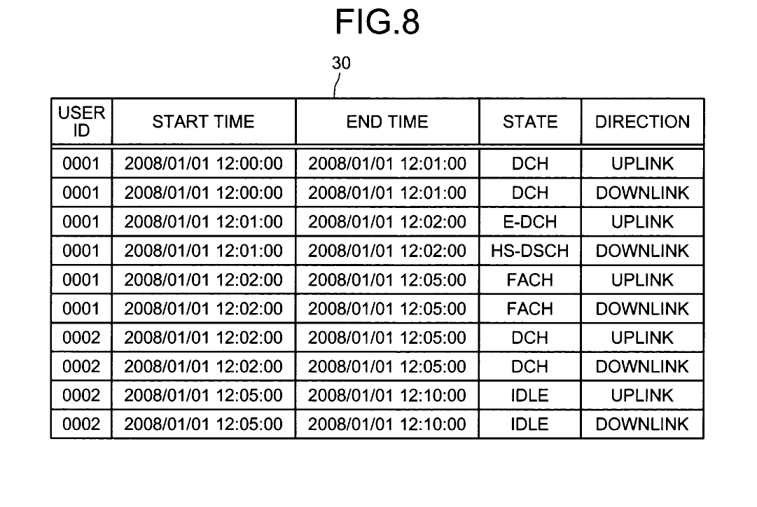

The acquiring unit 27 acquires, for each terminal, the wireless channel state of the wireless control unit 23. According to terminal, wireless channel state, and direction (uplink/downlink), the storage unit 30 stores the wireless channel state information acquired by the acquiring unit 27. In FIG. 8, an example of the information stored in the storage unit 30 is depicted.

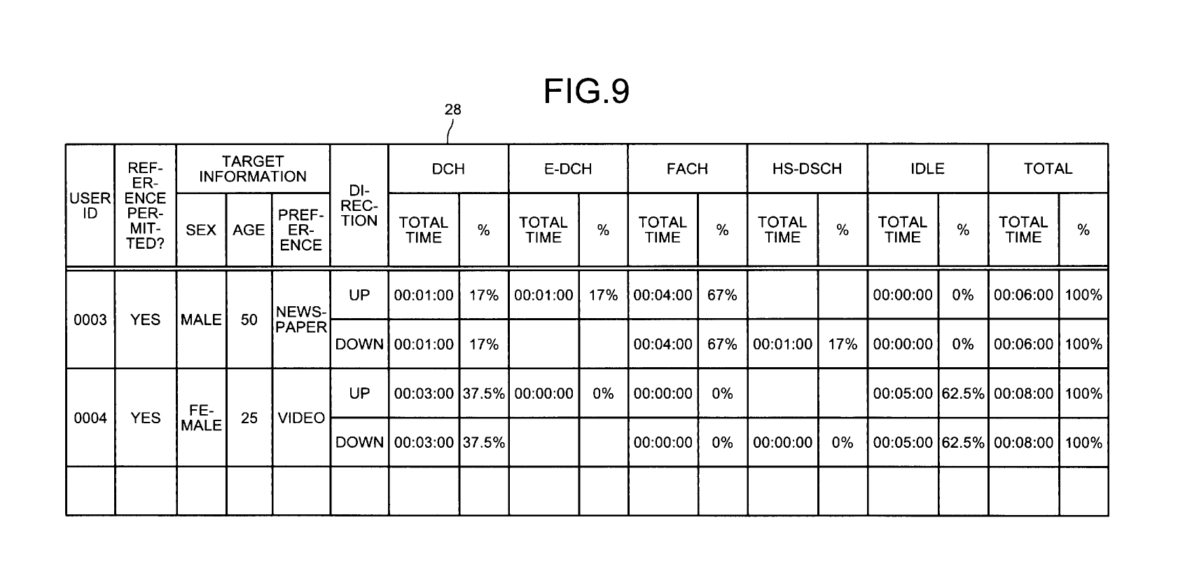

FIG. 8 depicts an example of the information stored in the storage unit. As depicted in FIG. 8, information concerning, for example, user IDs respectively assigned to each user, time of connection, time of disconnection, wireless channel state, and direction (uplink/downlink), is stored in the storage unit 30. The analyzing unit 29 analyzes the information stored in the storage unit 30 and from the information stored in the utilization state database 28, extracts advertisement target information for the wireless channel state coinciding with the analysis results or the advertisement target information for the wireless channel state most closely coinciding with the results. Further, the analyzing unit 29 writes the analysis results to the utilization state database 28. The utilization state database 28 stores information related to terminal users, correlated with the utilization state of the wireless channel. In FIG. 9, an example of the information stored in the utilization state database 28 is depicted.

FIG. 9 depicts an example of the information stored in the utilization state database. As depicted in FIG. 9, in the utilization state database 28, personal information such as user ID, sex, age, preferences, and information indicating whether the personal information may be referenced are given as examples of the information related to terminal users. Further, the total time of each communication state (DCH, E-DCH, FACH, HS-DSCH, and idling) as well as the percentage that each occupies of the total communication time including idling are given as examples of information concerning the utilization state of the wireless channel. The utilization state database 28 corresponds to a second database.

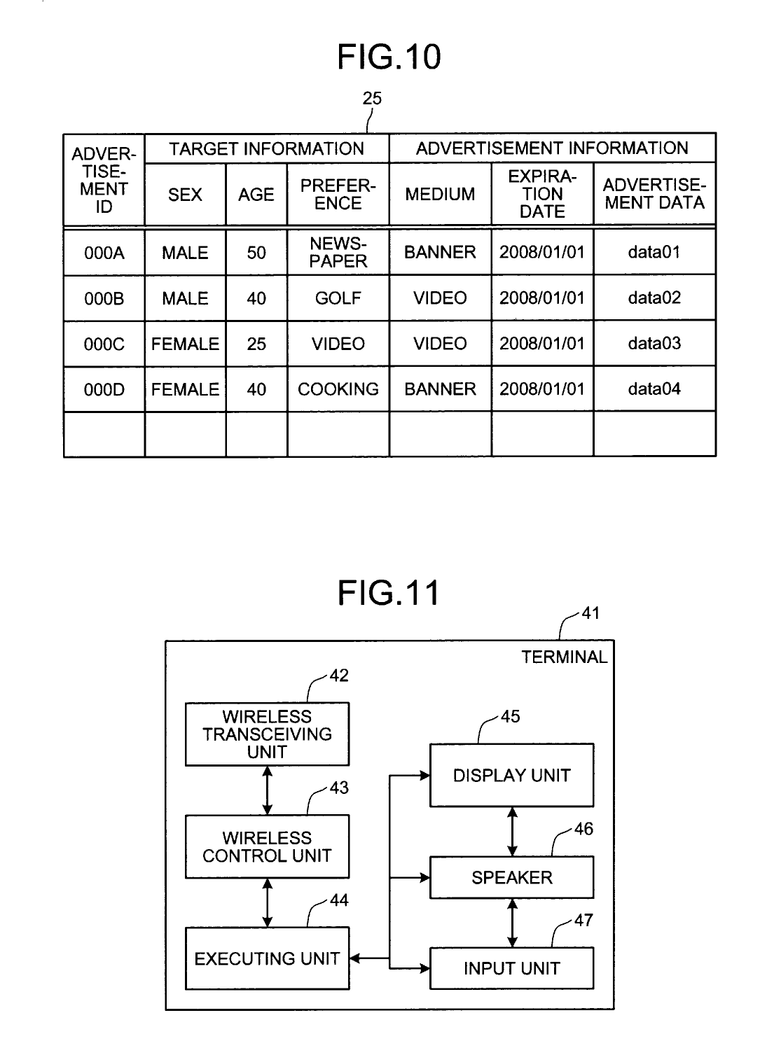

The delivering unit 26, from the advertisement information stored in the advertisement database 25, extracts an advertisement that coincides with the advertisement target information extracted by the analyzing unit 29 or an advertisement most closely coinciding with the advertisement target information. The delivering unit 26 transmits the extracted advertisement to the terminal, via the wireless control unit 23 and the wireless transceiving unit 24. Furthermore, the delivering unit 26 transmits the extracted advertisement to the display device, via the LAN interface unit 22. The advertisement database 25 stores advertisement information delivered from the advertising delivery provider. The advertisement database 25 deletes advertisement information whose validity has expired. In FIG. 10, an example of the information stored in the advertisement database 25 is depicted.

FIG. 10 depicts an example of information stored in the advertisement database. As depicted in FIG. 10, in the advertisement database 25, for example, an advertisement ID for each advertisement, advertisement target information, and advertisement information are stored. The advertisement information includes, for example, the type of advertisement medium, the validity of the advertisement, and advertisement data. Advertisement data is, for example, binary data. Types of advertisement media include, for example, banners that include video, audio, images, or text; moving pictures; and still pictures. Advertisement data is, for example, data implementing advertisements commissioned by business entities, such as new product information, new services, magazines and other advertisements. Advertisement target information includes, for example, the sex, the age, and the preferences targeted by the advertisements. The advertisement database 25 corresponds to a first database.

The managing unit 31 transmits to a mobile communications provider, via the LAN interface unit 22, information stored in the utilization state database 28. Further, the managing unit 31 manages the timing at which the analyzing unit 29 analyzes the wireless channel state and the timing at which the delivering unit 26 delivers advertisement information. A fixed interval or a time when communication processing at the wireless base station 21 is low (e.g., a period late at night when there are few telephone calls) may be given as an example of a timing for the start of analysis by the analyzing unit 29. The LAN interface unit 22 is a local area network interface, having an Internet protocol (IP) address, domain name system (DNS) information, etc. The LAN interface unit 22 is, for example, physically or wirelessly connected to a router.

The wireless control unit 23 and the wireless transceiving unit 24 operate as the wireless communications unit 3 of the fourth embodiment. The acquiring unit 27, the analyzing unit 29, and the storage unit 30 operate as the analysis unit 4 of the fourth embodiment. The advertisement database 25, the utilization state database 28, and the managing unit 31 operate as the control unit 5 of the fourth embodiment.

FIG. 11 depicts a configuration of a terminal of the fifth embodiment. The terminal is used, for example, when the user communicates via an internet such as a web or performs audio communication via a public line/other communications network. Further, the terminal uses advertisement data, displays advertisements such as video and text, and can output audio. As depicted in FIG. 11, a terminal 41 includes a wireless transceiving unit 42, a wireless control unit 43, an executing unit 44, a display unit 45, a speaker 46, and an input unit 47.

The wireless transceiving unit 42, based on 3GPP communication control standards, transmits and receives wireless signals by a physical channel between the terminal 41 and the wireless base station 21. The wireless control unit 43, based on 3GPP communication control standards, controls the communication connection (session), a wireless channel (transport channel), etc. between the terminal 41 and the wireless base station 21. The executing unit 44 executes the display of web information, audio telephone communication, a game that uses the network, etc. The display unit 45 includes a display screen such as a liquid crystal panel and displays the results of the execution by the executing unit 44. Furthermore, the display unit 45 displays advertisements that include video, images, and/or text. The speaker 46 outputs audio reproduced consequent to the execution by the executing unit 44. The speaker 46 further outputs advertisements that include audio. The input unit 47 receives commands, the URL of a website, etc. input by the user.

The wireless transceiving unit 42 and the wireless control unit 43 operate as the wireless communications unit 6 of the fourth embodiment. The display unit 45 and the speaker 46 operate as the output unit 7 of the fourth embodiment.

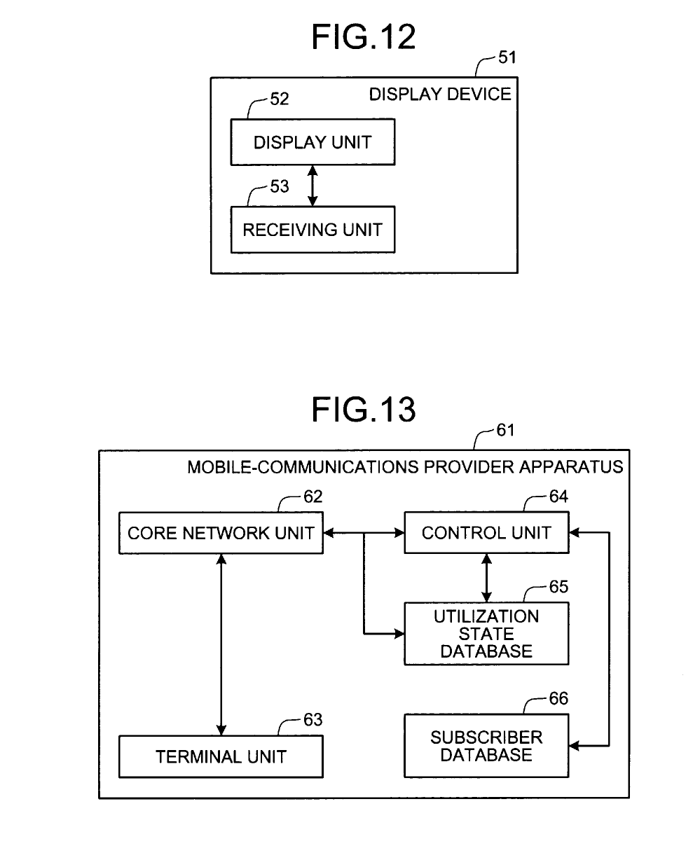

FIG. 12 depicts a configuration of a display device of the fifth embodiment. The display device corresponds to the reporting apparatus 8 of the fourth embodiment. The display device, for example, is installed at a store or place for exhibition, and displays advertisements for the user as well as others, who are in the store or at the place for exhibition. As depicted in FIG. 12, a display device 51 includes a display unit 52 and a receiving unit 53. The receiving unit 53 receives data delivered from the wireless base station 21. The display unit 52 includes a display screen such as a liquid crystal display, a plasma display, electronic paper, etc. and displays the advertisement data received by the receiving unit 53. The display device 51 may further include a speaker.

FIG. 13 depicts a configuration of a mobile-communications provider apparatus of the fifth embodiment. A mobile communications provider is service provider that provides to the user, a communication service used by the terminal 41. As depicted in FIG. 13, a mobile-communications provider apparatus 61 includes a core network unit 62, a terminal unit 63, a control unit 64, a utilization state database 65, and a subscriber database 66.

The core network unit 62 is a gateway for an internet and/or a public line/other communications network, manages the communication state of users, and performs billing processing and the like. The terminal unit 63 is connected to an internet and communicates, via the internet, with a multiplicity of the wireless base stations 21 installed at residences, offices, and commercial entities. The control unit 64 causes information stored in the utilization state database 28 of the wireless base station 21 to be transmitted to the utilization state database 65. The control unit 64 manages the timing at which the analyzing unit 29 of the wireless base station 21 analyzes the wireless channel state and the timing at which the delivering unit 26 of the wireless base station 21 delivers advertisement information. The control unit 64 extracts from the subscriber database 66, as the utilization state database 65, information of a potential user and searches the utilization state database 65 for information of the utilization state of the wireless channel, presumed to be that of the extracted user. If information of the user is present in the utilization state database 65, the control unit 64 updates the corresponding information in the utilization state database 65, using the sex, age, and preference information of the user stored in the subscriber database 66.

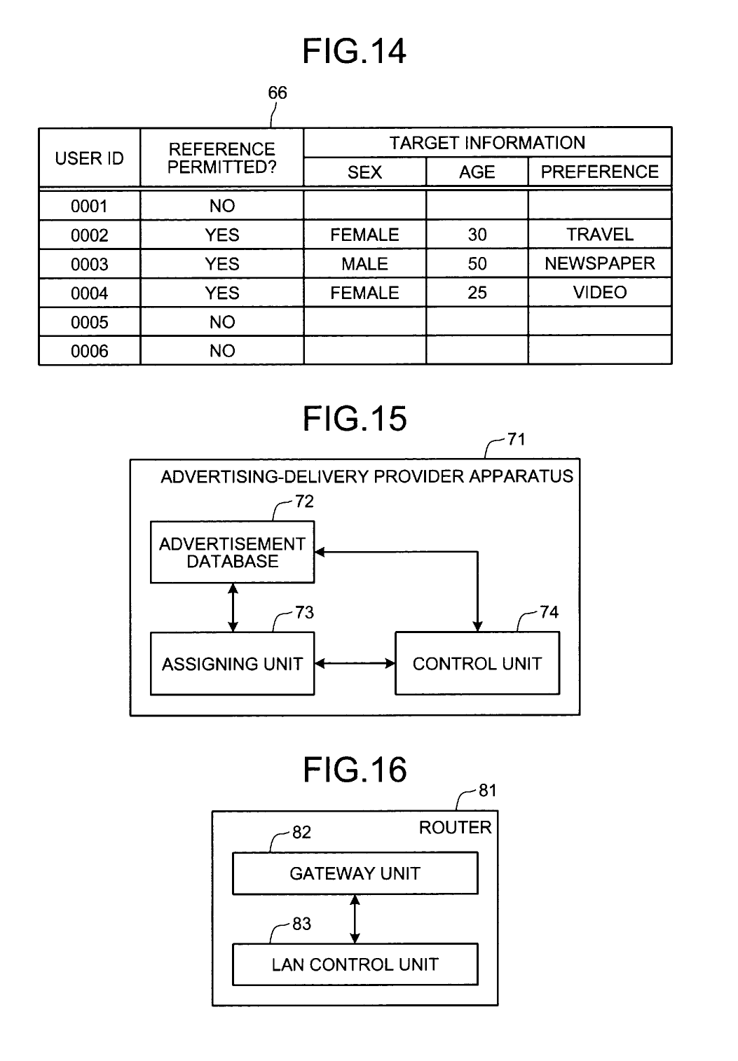

The utilization state database 65 stores information that is received from the wireless base station 21 and stored in the utilization state database 28 the wireless base station 21. Information stored in the utilization state database 65, for example, is that depicted in FIG. 9. The subscriber database 66 stores information concerning subscribers contracted with the mobile communications provider. In FIG. 14, an example of the information stored in the subscriber database 66 is depicted.

FIG. 14 depicts an example of the information stored in the subscriber database. As depicted in FIG. 14, in the subscriber database 66, concerning users for which “YES” is indicated for “Reference Permitted?”, sex, age, and preference information is preliminarily acquired and is therefore, stored as target information. Concerning users for which “NO” is indicated for “Reference Permitted?”, sex, age, and preference information is not stored.

FIG. 15 depicts a configuration of an advertising-delivery provider apparatus of the fifth embodiment. An advertising delivery provider is service provider that undertakes the delivery of advertisements from business entities and further databases and stores advertisements commissioned by the business entities. Business entity advertisements include, for example, new product information, new services, magazines and other advertisements. In an advertising-delivery provider apparatus 71, an advertisement database 72 stores advertisement information for business entities, etc. Information stored in the advertisement database 72, for example, is that depicted in FIG. 10. An assigning unit 73 assigns to advertisement information stored in the advertisement database 72, necessary target information as advertisement delivery destinations. The target information, for example, is input by the advertising delivery provider, based on the requests, etc. of the commissioning entity. Examples of target information include sex, age, and preferences. A control unit 74 controls the timing at which the assigning unit 73 starts operations of assigning target information and causes information stored in the advertisement database 72 to be transmitted to the advertisement database 25 of the wireless base station 21. The assigning unit 73 and the control unit 74 are connected to an internet.

FIG. 16 depicts a configuration of a router of the fifth embodiment. As depicted in FIG. 16, a router 81 includes a gateway unit 82 and a LAN control unit 83. The LAN control unit 83 controls a LAN and controls the bi-directional communication with the wireless base station 21 and the display device 51 on the LAN. The gateway unit 82 is a gateway connected to an internet, and transmits and receives, via the internet, signals with respect to the mobile-communications provider apparatus 61 and the advertising-delivery provider apparatus 71.

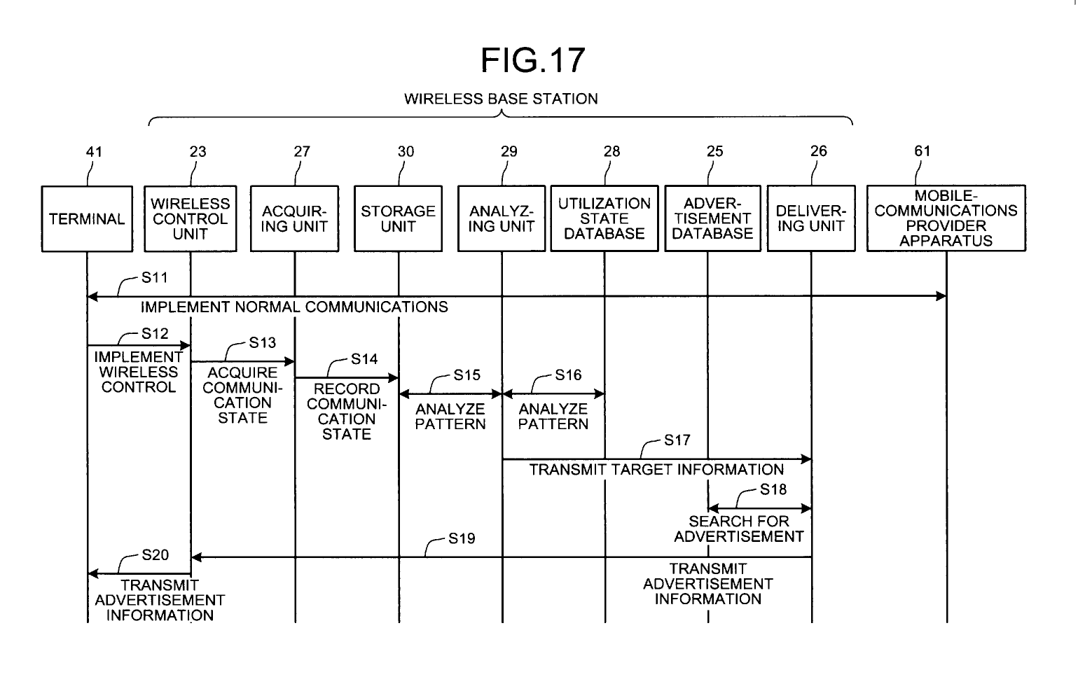

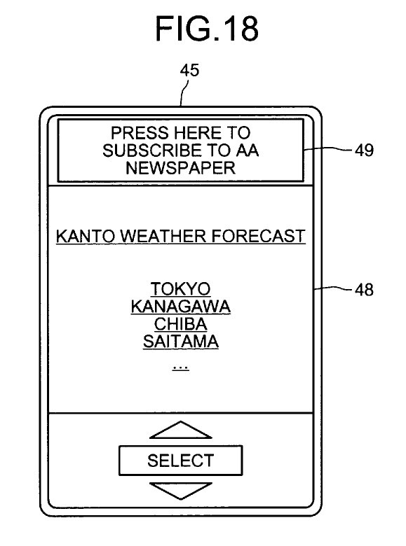

FIG. 17 depicts operation for delivering an advertisement to a terminal, in the fifth embodiment. As depicted in FIG. 17, when normal communication is implemented between the terminal 41 and the mobile-communications provider apparatus 61 (step S11), the wireless control unit 23 of the wireless base station 21 controls the connection (session), wireless channel (transport channel), etc. between the wireless base station 21 and the terminal 41 (step S12). Next, the acquiring unit 27 acquires from the wireless control unit 23 and for each terminal, for example, the wireless channel state information depicted in FIG. 7 (step S13) and records to the storage unit 30, the information for each terminal (step S14). Next, the analyzing unit 29, with respect to, for example, the information stored in the storage unit 30 depicted in FIG. 8, analyzes patterns of the utilization state of the wireless channel (step S15). Next, the analyzing unit 29, with respect to the information stored in the utilization state database 28, analyzes patterns in the utilization state of the wireless channel (step S16). Then, the analyzing unit 29 compares the patterns of the utilization state of the wireless channel; selects from among the patterns of the information stored in the utilization state database 28, the pattern closest to the pattern of information stored in the storage unit 30; and transmits to the delivering unit 26, router gate information included in the selected information (step S17). Triggered by the managing unit 31, the delivering unit 26 searches the advertisement database 25 for an advertisement coinciding with the target information or an advertisement most closely coinciding with the target information (step S18) and transmits the retrieved advertisement information to the wireless control unit 23 (step S19). Next, the wireless control unit 23 transmits the advertisement information to the targeted terminal (step S20), whereby advertisement information pertinent to the user of the terminal 41 is delivered to this targeted terminal 41. In FIG. 18 an example of display by the terminal 41 is depicted.

FIG. 18 depicts an example of display by the terminal. In the example depicted in FIG. 18, consequent to user operation, for example, a display 48 of “Kanto weather forecast Tokyo . . . ” for the web is displayed on the display unit 45 of the terminal 41 and above the display 48, an advertisement 49 of “Press here to subscribe to AA newspaper”, for example, is displayed as a banner. Before the advertisement is delivered the advertisement for “AA newspaper” is not displayed. This example corresponds, for example, to a user preference of “newspaper”. The advertisement may be displayed over the entire display unit 45, for example, using moving pictures, still pictures, text, etc. Further, audio may be output simultaneously with display, or audio alone may be used for the advertisement.

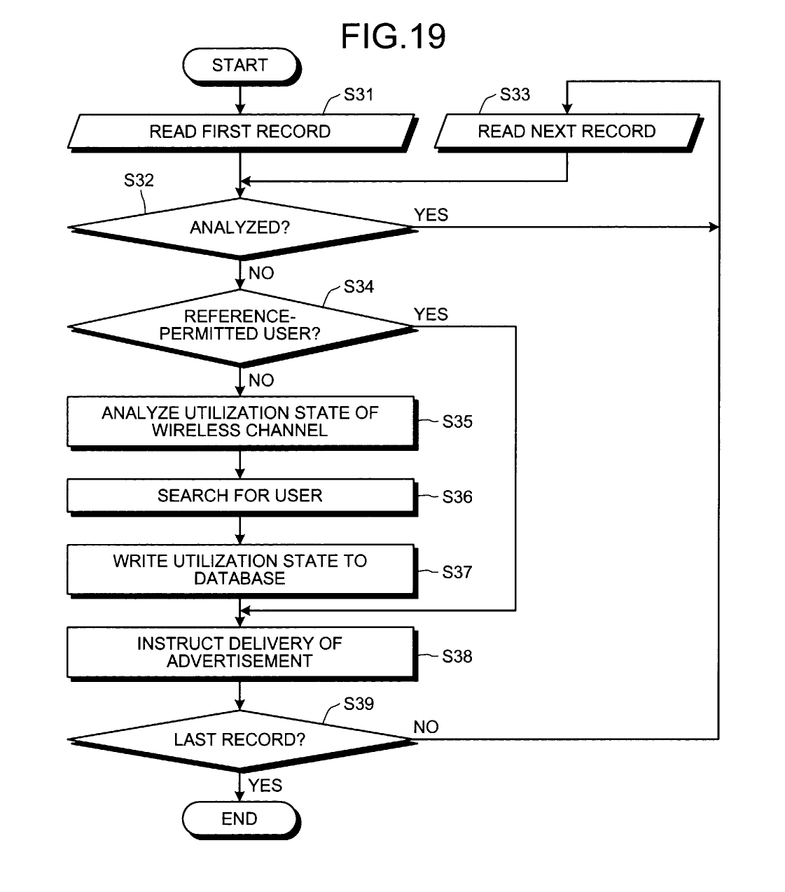

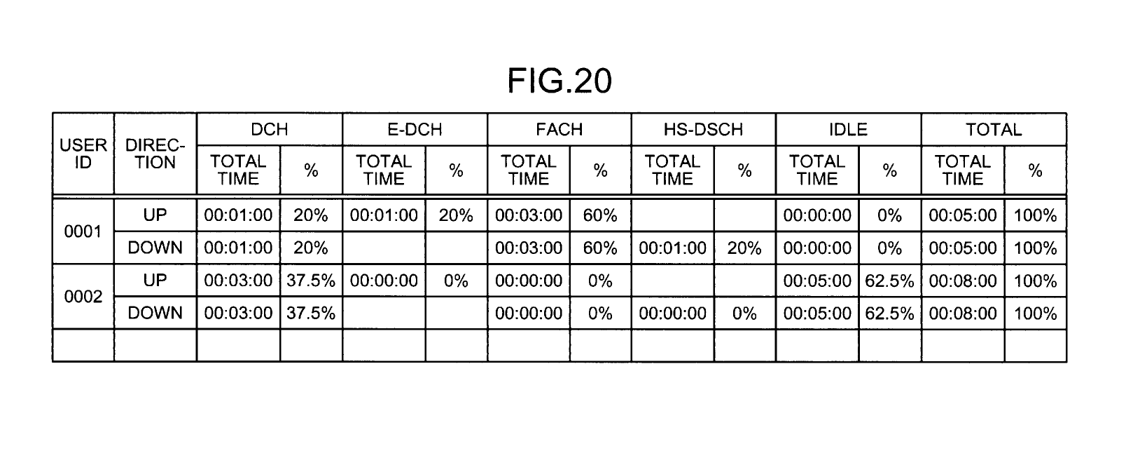

FIG. 19 depicts a process of analyzing wireless channel state and writing to the utilization state database in the fifth embodiment. As depicted in FIG. 19, the process of analyzing wireless channel state and writing to the utilization state database is triggered by the managing unit 31 of the wireless base station 21 or when a fixed period has elapsed since the start of user communication, upon which the first record of information stored in the storage unit 30 of the wireless base station 21 and for example, depicted in FIG. 8 is read (step S31). Next, it is determined whether analysis has been completed for the user recorded in the read record (step S32). If analysis has been completed (step S32: YES), the next record of information stored in the storage unit 30 is read (step S33) and again it is determined whether analysis for the user has been completed (step S32). At step S31 or at step S33, if analysis for the user in the read record has not be completed (step S32: NO), it is determined whether the user is one for whom personal information can be referenced (step S34). If the user is not one for whom personal information can be referenced (step S34: NO), the utilization state of the wireless channel is analyzed for the user, where for each wireless channel state and each direction, the total connection time therefor and the percentage that the total connection time occupies in the total communication time including idle states is determined (step S35). In FIG. 20, an example of analysis results for the utilization state of the wireless channel of a user are depicted.

FIG. 20 depicts an example of analysis results for the utilization state of the wireless channel of a user. The analysis results depicted in FIG. 20 are the results obtained by analyzing, for example, the information stored in the storage unit 30 depicted in FIG. 8.

In FIG. 19, in the information stored, for example, in the utilization state database 28 depicted in FIG. 9, the utilization state of the wireless channel that coincides with the analysis results or the closest user is searched for (step S36). As a search method, the following method may be used. As one example, a method of search the utilization state database 28 depicted in FIG. 9, for a user closest to the user corresponding to the user ID 001 in the analysis results depicted in FIG. 20 will be described. For each user for whom personal information can be referenced (in FIG. 9, users for whom the value in the Reference Permitted? field is “YES”), the degree of communication state consistency is calculated for each user using the following equation, where #### represents DCH, E-DCH, FACH, HS-DSCH, and idle.

degree of communication state consistency=Σ{|[reference-permitted user ####(uplink) ratio]−[user 0001 ####(uplink) ratio]|+|[reference-permitted user####(downlink) ratio]−[user 0001 ####(downlink) ratio]|}

According to this equation, the closer the utilization state of the wireless channel is between the reference-permitted user and user 0001, the smaller the value of the degree of consistency becomes. Calculation by this equation yields a degree of consistency of 18 between user 0001 and a reference-permitted user 0003 and a degree of consistency of 320 between user 0001 and a reference-permitted user 0004. Therefore, the target information for the reference-permitted user 0003 depicted in FIG. 9 can be applied to the user 0001. If degrees of consistency are obtained for the user having user ID 0002, the value of the degree of consistency between user 0002 and a reference-permitted user 0004 is the smallest. Therefore, for user 0002, the target information for the reference-permitted user 0004 depicted in FIG. 9 can be applied. Nonetheless, the search method is not limited hereto.

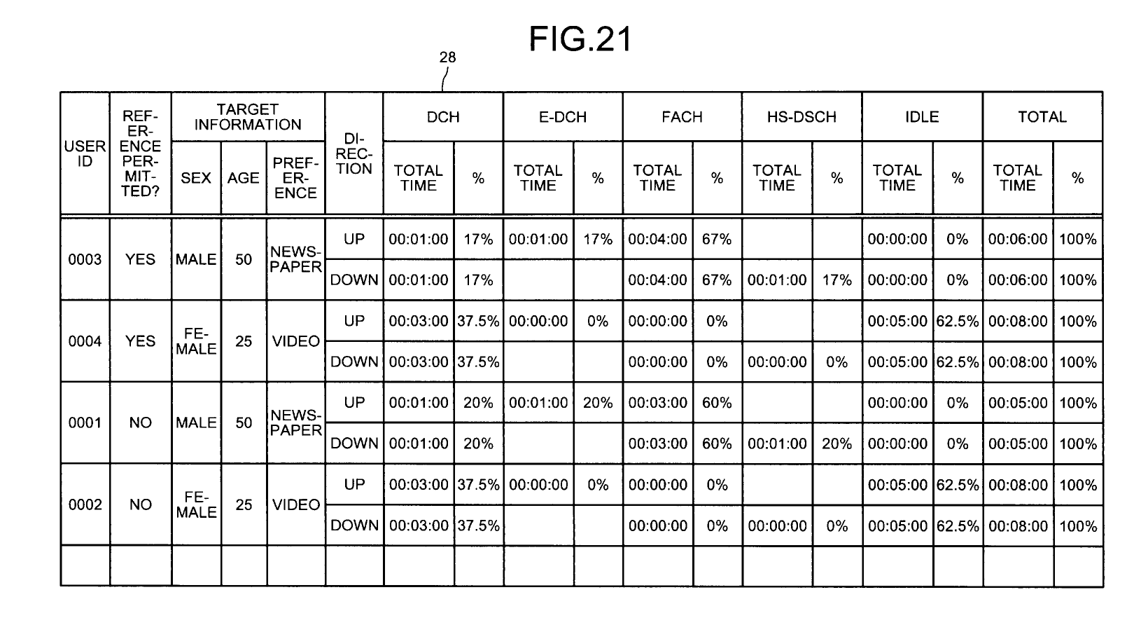

Next, the analysis results obtained at step S35 for the utilization state of the wireless channel and the target information of the reference-permitted user retrieved at step S36 are correlated and are written to the utilization state database 28 as information of the user subject to the analysis at step S35 (step S37). In FIG. 21, an example of the utilization state database 28 to which the analysis results have been written is depicted.

FIG. 21 depicts an example of the utilization state database after the analysis results have been written thereto. As depicted in FIG. 21, with respect to the utilization state database 28 depicted in FIG. 9, user 0001 and user 0002 have been added and the respective target information therefor is that of user 0003 and user 0004.

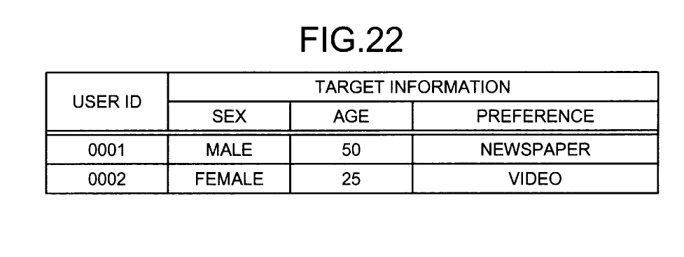

In FIG. 19, the delivering unit 26 is instructed to deliver to the user subject to the analysis at step S35, the advertisement based on the target information in the utilization state database 28 after the analysis results have been written thereto (step S38). In FIG. 22, an example of information for instructing the delivering unit 26 is depicted.

FIG. 22 depicts an example of information for instructing the delivering unit. As depicted in FIG. 22, user ID and target information are given to the delivering unit 26 and sex, age, and preferences are router gate information, for example.

In FIG. 19, at step S34, if the user is one for whom personal information can be referenced (step S34: YES), the flow proceeds to step S38 without performing steps S35 to S37, and the delivering unit 26 is instructed to deliver the advertisement. After the delivery of the advertisement is instructed, it is determined whether the record under processing is the last record stored in the storage unit 30 (step S39). If the record is not the last record (step S39: NO), the flow returns to step S33 and steps S32 to step S39 are repeated. If the record is the last record (step S39: YES), the processing ends.

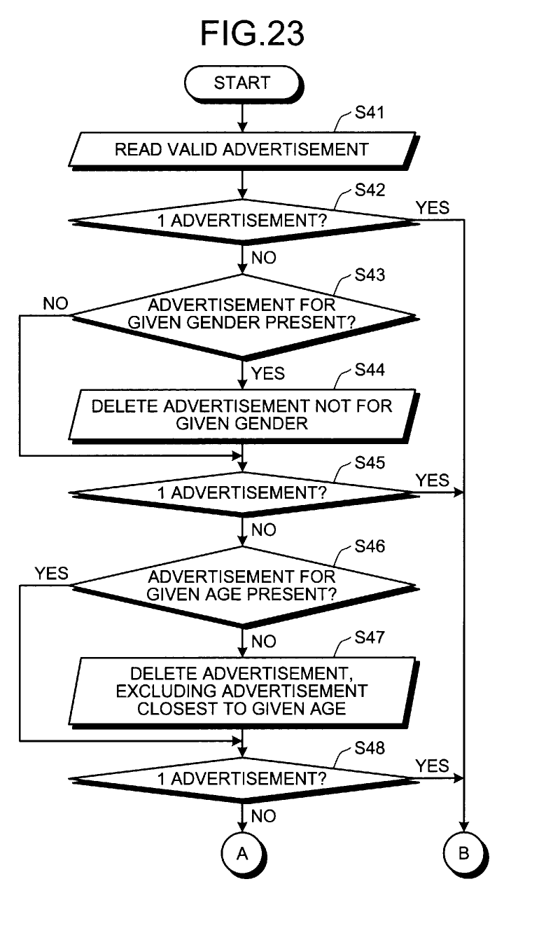

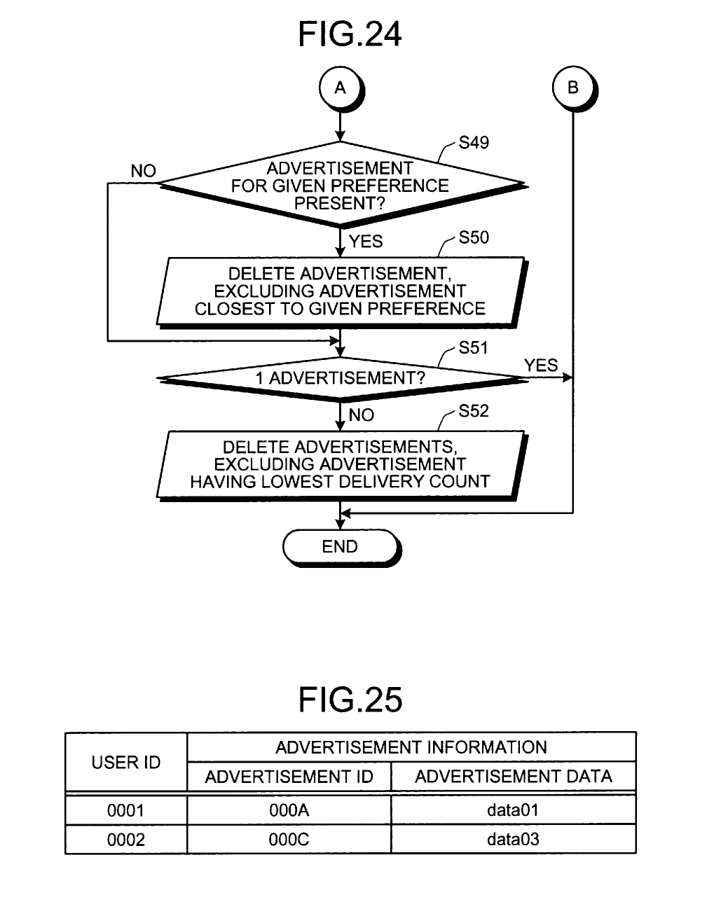

FIG. 23 depicts a process of searching the advertisement database for an advertisement, in the fifth embodiment. FIG. 24 depicts a continuation of the process depicted in FIG. 23. As depicted in FIGS. 23 and 24, upon the start of the process of searching the advertisement database for an advertisement, first, all valid advertisement information is read from the advertisement database 25 (step S41). It is determined whether the number of read advertisements is 1 (step S42). If the number of advertisements is 1 (step S42: YES), the search process ends. If the number of advertisements is not 1 (step S42: NO), it is determined whether an advertisement targeting the gender of the targeted user is present (step S43). If no advertisement targeting the gender is present (step S43: NO), it is determined whether the number of advertisements is 1 (step S45). If an advertisement targeting the gender is present (step S43: YES), advertisements not targeting the gender are deleted (step S44), and it is determined whether the number of advertisements that remain is 1 (step S45).

If the number of advertisements is 1 (step S45: YES), the search process ends. If the number of advertisements is not (step S45: NO), it is determined whether an advertisement targeting the age of the targeted user is present (step S46). If an advertisement targeting the age of the user is present (step S46: YES), it is determined whether the number of such advertisements is 1 (step S48). If no advertisement targeting the age of the user is present (step S46: NO), advertisements, excluding those targeting age(s) closest to the targeted user age, are deleted (step S47), and it is determined whether the remaining number of advertisements is 1 (step S48).

If the number of advertisements is 1 (step S48: YES), the search process ends. If the number of advertisements is not (step S48: NO), it is determined whether an advertisement targeting the preference of the targeted user is present (step S49). If an advertisement targeting the preference of the user is not present (step S49: NO), it is determined whether the number of advertisements is 1 (step S51). If an advertisement targeting the preference of the user is present (step S49: YES), advertisements, excluding those targeting a preference(s) closest to that of the user, are deleted (step S50), and it is determined whether the number of remaining advertisements is 1 (step S51). If the number of advertisements is 1 (step S51: YES), the search process ends. If the number of advertisements is not 1 (step S51: NO), advertisements, excluding the advertisement(s) having the lowest delivery count, are deleted (step S52), ending the process.

The advertisement(s) remaining at the completion of the search process are delivered from the delivering unit 26, via the wireless control unit 23. In FIG. 25, an example of information instructed to the wireless control unit 23 is depicted.

FIG. 25 depicts information instructed to the wireless control unit. As depicted in FIG. 25, user ID, advertisement ID and advertisement data are instructed to the wireless control unit 23. The advertisement data is, for example, binary data.

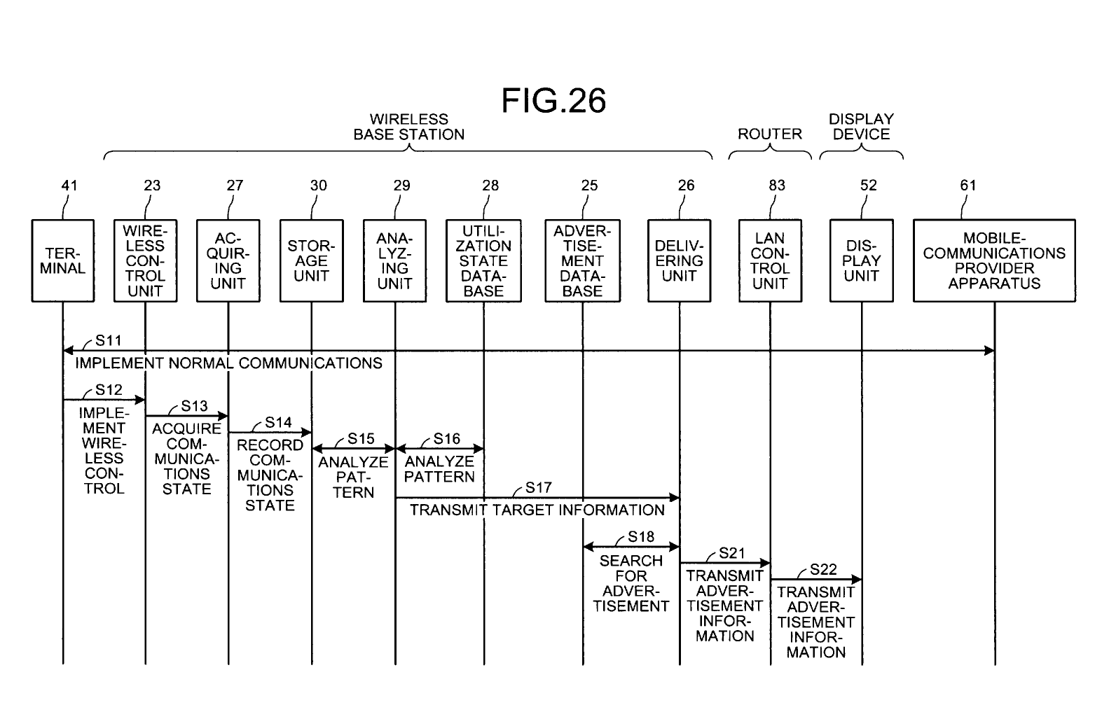

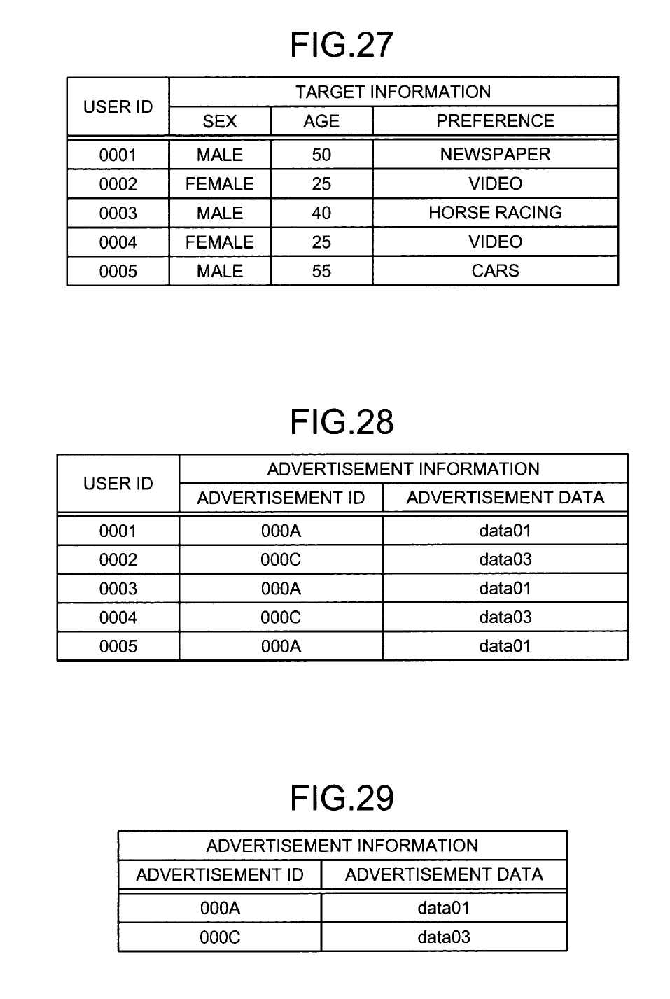

FIG. 26 depicts operation for delivering an advertisement to a display device, in the fifth embodiment. As depicted in FIG. 26, steps S11 to S18 are identical to the operation depicted in FIG. 17, for delivering an advertisement to a terminal. At step S18, after searching the advertisement database 25 for an advertisement coinciding with the target information or an advertisement closest to the target information, the delivering unit 26 transmits the retrieved advertisement information to the LAN control unit 83 of the router 81 (step S21). Next, the LAN control unit 83 transmits the advertisement information to the display device 51 (step S22), whereby advertisement information pertinent to the user(s) of the terminal 41 is displayed on the display unit 52 of the display device 51. In FIG. 27, an example of information transmitted to the delivering unit 26 is depicted.

FIG. 27 depicts an example of information transmitted to the delivering unit. As depicted in FIG. 27, user ID and target information are instructed to the delivering unit 26 and sex, age, and preferences are router gate information, for example. Using the example depicted in FIG. 27, the process depicted in FIGS. 23 and 24 is performed and an example of the selected advertisements to be displayed for each user is depicted in FIG. 28. Further, for the example depicted in FIG. 28, an example of information transmitted to the receiving unit 53 of the display device 51 is depicted in FIG. 29.

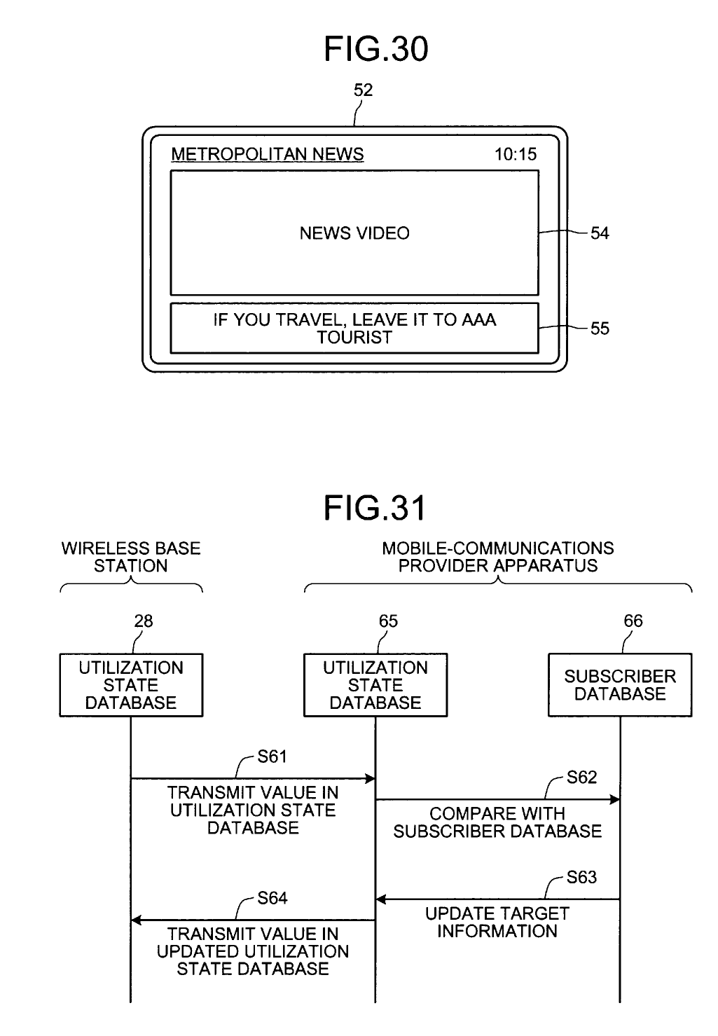

FIG. 28 depicts an example of selected advertisements to be displayed for each user. FIG. 29 depicts an example of information transmitted to the receiving unit of the display device. Advertisement data having an advertisement ID of 000A and advertisement data having an advertisement ID of 000C in the example depicted in FIG. 28 are selected. As depicted in FIG. 29, these two advertisement IDs and corresponding data are transmitted to the receiving unit 53 of the display device 51, the order of which can be changed according to priority, and for example, are transmitted by a file transfer protocol (FTP) transfer through an IP connection. Priority, for example, increases as the number of hits increases. In FIG. 30, a display example of the display device 51 is depicted.

FIG. 30 depicts a display example of the display device. In the example depicted in FIG. 30, on the display unit 52 of the display device 51, for example, news video 54 is displayed as “Metropolitan News”, below which an advertisement 55, “If you travel, leave it to AAA Tourist”, is displayed, for example, as a moving picture. Before the advertisement is delivered, the advertisement “If you travel, leave it to AA Tourist” is not displayed. This example corresponds to a case where, for example, the user preference is travel. On the entire display unit 52 or a portion thereof, an advertisement(s) may displayed by, for example, a moving picture(s), a still picture(s), and/or text. Furthermore, audio may be output simultaneously with display, or audio along may be used for the advertisement. If audio is used for an advertisement, the display device 51 has a speaker.

When the information depicted in FIG. 27 is delivered to the delivering unit 26 of the wireless base station 21, the intended user is communicating with the wireless base station 21 or was just communicating with the wireless base station 21. In other words, the user is within a range enabling communication with the wireless base station 21. Therefore, by displaying an advertisement on the display device 51, an advertisement pertinent to the user can be displayed. If there are multiple advertisements to be displayed or output, the advertisements may be displayed or output in descending order of priority, the duration that the advertisement is displayed or output maybe increased in descending order of priority, etc. Alternatively, the frequency of the display or output of the advertisement may be increased in descending order of priority.

FIG. 31 depicts operation for updating the utilization state database in the fifth embodiment. As depicted in FIG. 31, a value in the utilization state database 28, for example, depicted in FIG. 21 and to which the analysis result has been written is transmitted from the utilization state database 28 of the wireless base station 21 to the utilization state database 65 of the mobile-communications provider apparatus 61 (step S61). The control unit 64 of the mobile-communications provider apparatus 61 compares the utilization state database 65 of the mobile-communications provider apparatus 61, overwritten with the value in the utilization state database 28 of the wireless base station 21 with, for example, the subscriber database 66 depicted in FIG. 14 (step S62), and uses the target information in the subscriber database 66 to update the target information in the utilization state database 65 (step S63). Next, the updated value in the utilization state database 65 of the mobile-communications provider apparatus 61 is transmitted from the utilization state database 65 of the mobile-communications provider apparatus 61 to the utilization state database 28 of the wireless base station 21, and the value in the utilization state database 28 of the wireless base station 21 is overwritten (step S64).

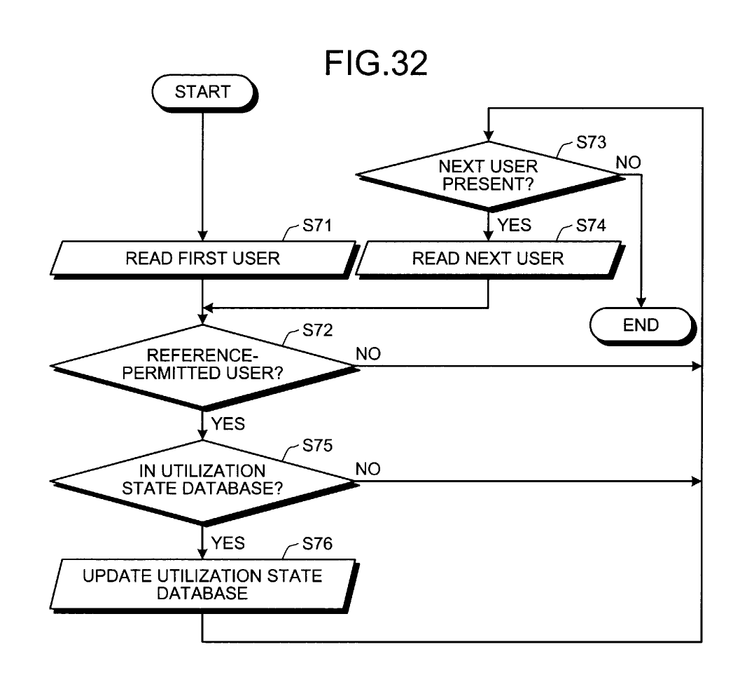

FIG. 32 depicts a process of updating the utilization state database in the fifth embodiment. As depicted in FIG. 32, at the mobile-communications provider apparatus 61, upon the start of the process of updating the utilization state database 65, first, the control unit 64 of the mobile-communications provider apparatus 61 reads the first user information recorded in the subscriber database 66 (step S71). Next, the control unit 64 determines whether the read user is one for whom personal information can be referenced (step S72). If the user is one for whom personal information cannot be referenced (step S72: NO), the control unit 64 determines whether a subsequent record of user information is in the subscriber database 66 (step S73). If subsequent user information is not recorded (step S73: NO), the process ends.

If subsequent user information is recorded (step S73: YES), the control unit 64 reads the subsequent record of user information (step S74), and determines whether the user is one for whom personal information can be referenced (step S72). At step S71 or step S74, if the read user is one for whom personal information can be referenced (step S72: YES), the control unit 64 determines whether information for the user is in the utilization state database 65 (step S75). If information for the user is not in the utilization state database 65 (step S75: NO), the control unit 64 returns to step S73, and repeats steps S72 to S75.

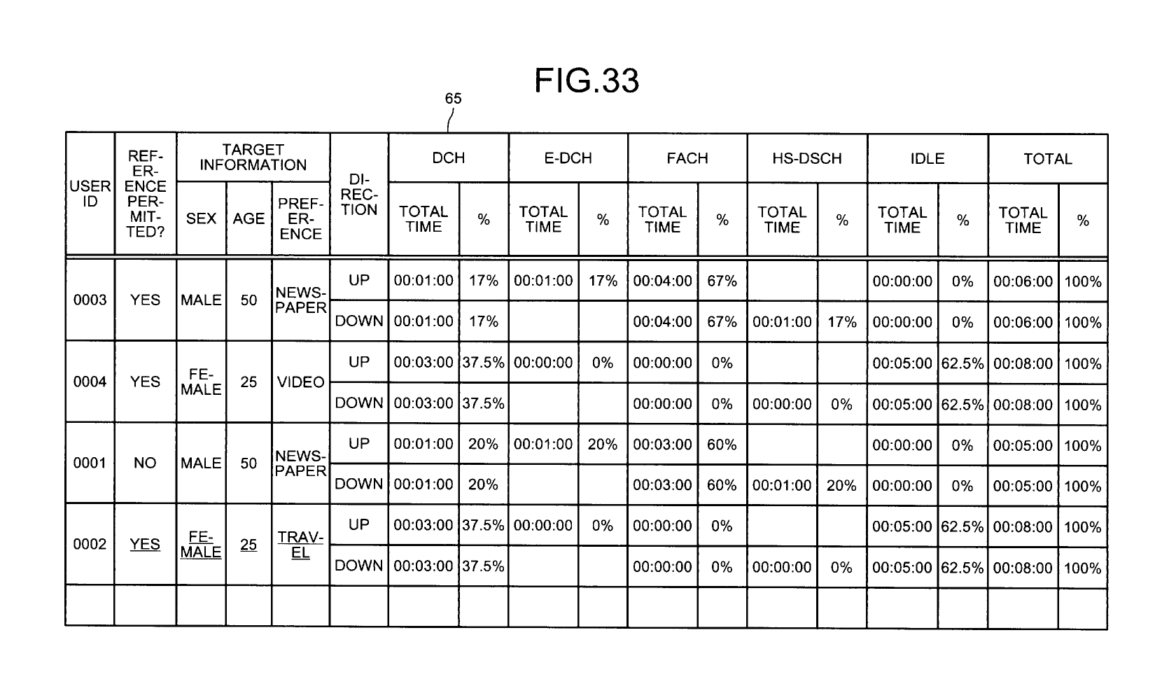

If information for the user is in the utilization state database 65 (step S75: YES), the control unit 64 uses the target information stored in the subscriber database 66 for the user, to update the corresponding information in the utilization state database 65 (step S76). The control unit 64 returns to step S73 and repeats steps S72 to S76 until no subsequent user information remains in the subscriber database 66. In FIG. 33, an example of the utilization state database 65 after updating is depicted.

FIG. 33 depicts an example of the utilization state database after updating. In the example depicted in FIG. 33, updated items are underlined, e.g., user information for user ID 0002 has been updated. For example, the utilization state database 28 of the wireless base station 21 depicted in FIG. 21 is similarly updated as in the example depicted in FIG. 33.

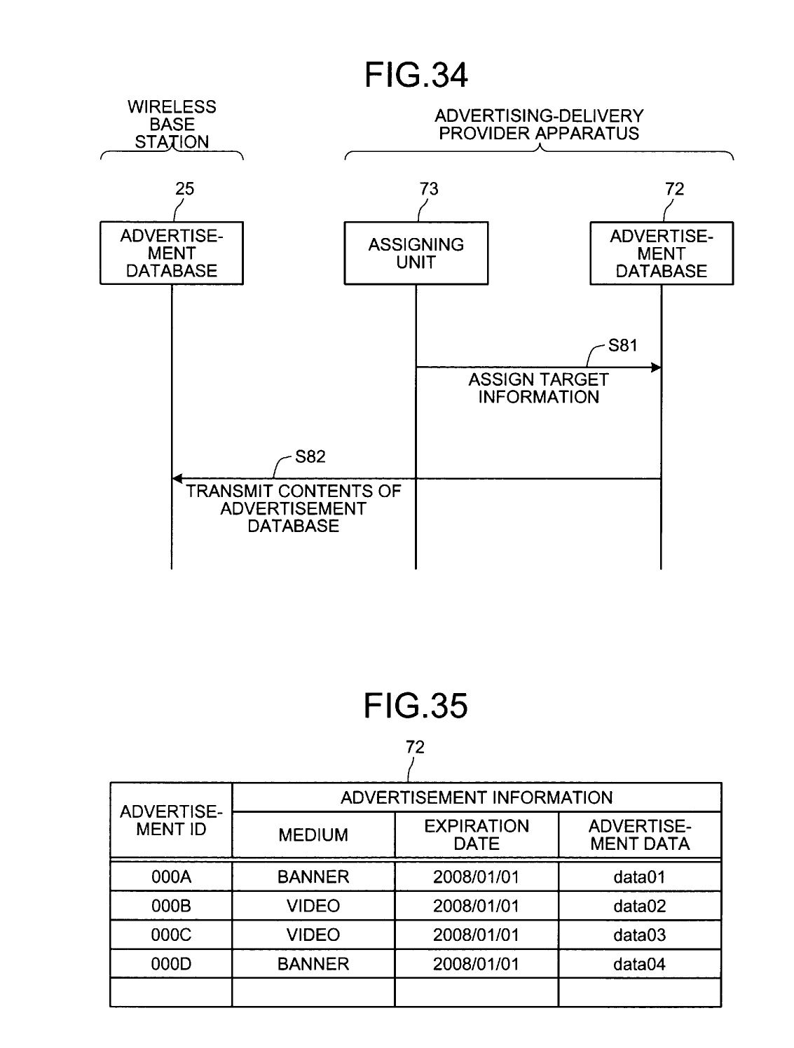

FIG. 34 depicts operation for delivering the advertisement database in the fifth embodiment. As depicted in FIG. 34, in the advertising-delivery provider apparatus 71, the assigning unit 73 assigns target information to the advertisement database 72, which has not been assigned target information (step S81). For example, sex, age, and preferences may be given as target information and router gate information is determined by the advertising delivery provider, based on advertisement content. Next, the contents of the advertisement database 72 having been assigned target information are transmitted from the advertising-delivery provider apparatus 71 to the wireless base station 21 and the contents of the advertisement database 25 of the wireless base station 21 are overwritten (step S82). In FIG. 35, an example of the advertisement database 72 to which target information has not been assigned is depicted.

FIG. 35 depicts an example of the advertisement database to which target information has not been assigned. An example of the advertisement database to which target information has been assigned is as depicted in FIG. 10. Although the example depicted in FIG. 10 is an example of the advertisement database 25 of the wireless base station 21, the advertisement database 72 of the advertising-delivery provider apparatus 71 is similar.

According to the fifth embodiment, since the wireless base station 21 delivers advertisement information to the terminal 41, according to the utilization state of the wireless channel used by the terminal 41, advertisement information pertinent to the user of the terminal 41 can be delivered from the wireless base station 21 and in doing so, the user need not perform any particular operation such as inputting a keyword into a search engine. Further, since the wireless base station 21 delivers advertisement information to the display device 51, according to the utilization state of the wireless channel used by the terminal 41, advertisement information pertinent to multiple users in the vicinity of the wireless base station 21 can be delivered from the wireless base station 21. Since the contents of the utilization state database 28 are transmitted from the wireless base station 21 to the mobile-communications provider apparatus 61, mobile communications provider can acquire the information stored in the utilization state database 28. Therefore, the mobile communications provider can utilize the information stored in the utilization state database 28 for marketing, to provide new services, etc. Furthermore, since the contents of the advertisement database 72 are transmitted from the advertising-delivery provider apparatus 71 to the wireless base station 21, the advertising delivery provider can update the contents of the advertisement database 25 of the wireless base station 21.

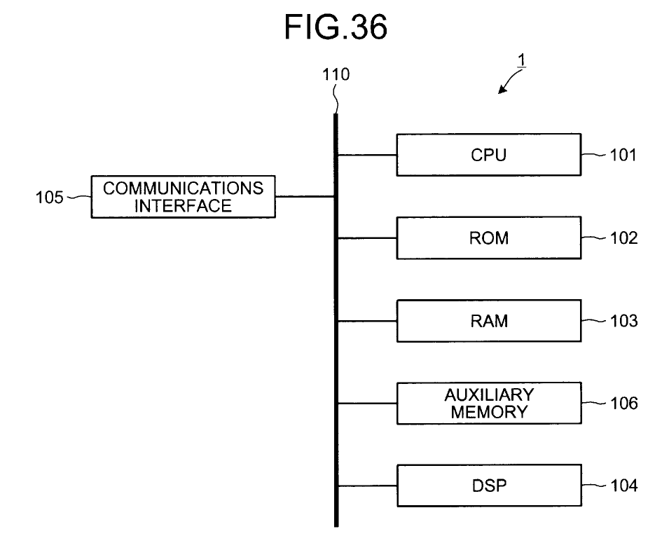

FIG. 36 depicts one example of a hardware configuration of the wireless base station 1. As depicted in FIG. 36, the wireless base station 1 includes a central processing unit (CPU) 101, ROM 102, RAM 103, a digital signal processor (DSP) 104, and a communications interface 105, respectively connected by a bus 110.

The CPU 101 executes programs stored to the ROM 102 and thereby governs overall control of the wireless base station 1. The RAM 103 is used as a work area of the CPU 301. Additionally, auxiliary memory 106 is provided and configuration may be such that programs are stored to non-volatile memory such as a hard disk and an optical disk. Programs stored to the auxiliary memory 106 are executed by the CPU 101.

The communications interface 105, for example, performs wireless communication between wireless base station 1 and external devices (e.g., the terminal 2). The communications interface 105 is controlled by the CPU 101.

The analysis unit 4 and the control unit 5 depicted in FIG. 1, for example, can be implemented by executing a program on the CPU 101. However, implementation is not limited to the use of the CPU 101. For example, the DSP 104 may be used. The wireless communications unit 3 depicted in FIG. 1 can be implemented by the communications interface 105.

Furthermore, the wireless control unit 23, the delivering unit 26, the acquiring unit 27, the analyzing unit 29, and the managing unit 31 depicted in FIG. 6 can be implemented by the CPU 101, the ROM 102, and the RAM 103. The advertisement database 25, the utilization state database 28, and the storage unit 30 also depicted in FIG. 6 can be implemented by the auxilliary memory 106. Additionally, in FIG. 6, the wireless control unit 23 and wireless transceiving unit 24 can be implemented by the DSP 104; and the LAN interface unit 22 can be implemented by the communications interface 105.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless base station comprising:
a communicator that performs wireless communication with a subordinate terminal, using any one among various types of wireless channels; and
a processor to control the wireless base station in accordance with a process including:
analyzing a utilization state of the wireless channel used by the terminal; and
controlling information delivered to the terminal, according to the analyzing results.

2. The wireless base station according to claim 1, further comprising
a first database that stores therein the information correlated with user information related to a user of the terminal.

3. The wireless base station according to claim 2, further comprising
a second database that stores therein the user information correlated with the utilization state of the wireless channel.

4. The wireless base station according to claim 1, wherein the processor delivers the information to the terminal.

5. The wireless base station according to claim 4, further comprising
an interface that outputs the information to a network.

6. A terminal comprising:
a communicator that performs wireless communication with a wireless base station, using any one among various types of wireless channels; and
an outputter that outputs information delivered from the wireless base station, according to the type of wireless channel used for the wireless communication with the wireless base station.

7. A wireless communication system performing wireless communication between a wireless base station and a subordinate terminal, using any one among various types of wireless channels, wherein:
the wireless base station analyzes a utilization state of the wireless channel used by the terminal and delivers information to the terminal, according to analysis results, and
the terminal outputs the information delivered from the wireless base station, according to the type of wireless channel used for the wireless communication with the wireless base station.

8. The wireless communication system according to claim 7,
wherein the wireless base station transmits to a wireless communications carrier, information correlating the utilization state of the wireless channel and information related to a user of the terminal.

9. The wireless communication system according to claim 7,
wherein the wireless base station updates the information that the wireless base station has, using information that an information provider has.

10. A wireless communication system that performs wireless communication between a wireless base station and a subordinate terminal, using any one among various types of wireless channels, wherein
the wireless base station analyzes a utilization state of the wireless channel used by the terminal and delivers according to analysis results, information to a reporting apparatus that reports the information to an unspecified target, and
the reporting apparatus outputs the information delivered from the wireless base station.

11. The wireless communication system according to claim 10,
wherein the wireless base station transmits to a wireless communications carrier, information correlating the utilization state of the wireless channel and information related to a user of the terminal.

12. The wireless communication system according to claim 10,
wherein the wireless base station updates the information that the wireless base station has, using information that an information provider has.

13. A wireless communications method of performing wireless communication between a wireless base station and a subordinate terminal, using any one among various types of wireless channels, the wireless communications method comprising:
analyzing, at the wireless base station, a utilization state of the wireless channel used by the terminal;
delivering according to analysis results obtained at the analyzing, information from the wireless base station to the terminal; and
outputting at the terminal, the delivered information.

14. The wireless communications method according to claim 13, further comprising
transmitting from the wireless base station to a wireless communications carrier, information correlating the utilization state of the wireless channel and information related to a user of the terminal.

15. The wireless communications method according to claim 13, further comprising
updating the information that the wireless base station has, using information that an information provider has.

16. A wireless communications method of performing wireless communication between a wireless base station and a subordinate terminal, using any one among various types of wireless channels, the wireless communications method comprising:
analyzing, at the wireless base station, a utilization state of the wireless channel used by the terminal;
delivering according to analysis results obtained at the analyzing, information from the wireless base station to a reporting apparatus that reports the information to an unspecified target; and
outputting at the reporting apparatus, the delivered information.

17. The wireless communications method according to claim 16, further comprising
transmitting from the wireless base station to a wireless communications carrier, information correlating the utilization state of the wireless channel and information related to a user of the terminal.

18. The wireless communications method according to claim 16, further comprising
updating the information that the wireless base station has, using information that an information provider has.
